(19) United States
(12) Patent Application Publication
(10) Pub. No.: US 2013/0111433 A1
(43) Pub. Date: May 2, 2013

(54) METHOD AND APPARATUS FOR GENERATING APPLICATION PROGRAMS

(71) Applicant: Xin Zhou, Beijing (CN)

(72) Inventor: Xin Zhou, Beijing (CN)

(73) Assignee: GOOGLE INC., Mountain View, CA (US)

(21) Appl. No.: 13/598,687

(22) Filed: Aug. 30, 2012

(30) Foreign Application Priority Data
Oct. 28, 2011 (CN) 201110332920.X

(51) Int. Cl. G06F 9/44

(52) U.S. Cl. 717/106

(57) ABSTRACT

Systems and methods are disclosed for generating an application program for a platform associated with a mobile device. The mobile device can receive a file describing a gadget application; extract from the file describing the gadget application, information associated with the gadget application; identify at least one template file configured for the platform associated with the mobile device; access content associated with generating the application program based at least in part on the information associated with the gadget application; and generate, at the mobile device, the application program based at least in part on the template file and the content associated with generating the application program.

### CROSS-REFERENCE TO RELATED APPLICATIONS

This application claims priority from Chinese Patent Application No. 201110332920.X, filed Oct. 28, 2011, which is incorporated herein by reference in its entirety.

### BACKGROUND

Gadget applications are also called widgets, components, miniature applications, mini apps, applets, gizmos. For example, a personal web page can include one or more gadget applications embedded in it. When a user visits the personal web page, the one or more gadget applications can be executed. A gadget application can be described in a file (e.g., an XML file). In some cases, a user can access the file describing the gadget application from a mobile device.

### SUMMARY

One aspect of the disclosed embodiments is a method for generating an application program for a platform associated with a mobile device. The method includes receiving, at the mobile device, a file describing a gadget application; extracting, from the file describing the gadget application, information associated with the gadget application; identifying, at least one template file configured for the platform associated with the mobile device; accessing content associated with generating the application program based at least in part on the information associated with the gadget application; and generating, at the mobile device, the application program based at least in part on the template file and the content associated with generating the application program.

Another aspect of the disclosed embodiments is a method for generating an application program for a platform. The method includes extracting, at a computing device, information associated with the gadget application from a file describing a gadget application; identifying at least one template file associated with the platform using at least some of the information associated with the gadget application; accessing content associated with generating the application program based at least in part on the information associated with the gadget application; and generating, at the computing device, the application program based on the template file and the content associated with generating the application program.

Another aspect of the disclosed embodiments is a computing device for generating an application program for a platform associated with the computing device. The computing device can comprise at least one memory and at least one processor. The processor can be configured to execute instructions stored in the at least one memory to: receive a file describing a gadget application; extract, from the file describing the gadget application, information associated with the gadget application; identify at least one template file configured for the platform associated with the computing device; access content associated with generating the application program based at least in part on the information associated with the gadget application; and generate the application program based at least in part on the template file and the content associated with generating the application program.

Another aspect of the disclosed embodiments is a non-transitory computer-readable medium having computer-executable instructions stored thereon. When the instructions are executed by a computing device, the instructions can cause the computing device to: receive a file describing a gadget application; extract, from the file describing the gadget application, information associated with the gadget application; identify at least one template file configured for the platform associated with the computing device; access content associated with generating the application program based at least in part on the information associated with the gadget application; and generate the application program based at least in part on the template file and the content associated with generating the application program.

### BRIEF DESCRIPTION OF THE DRAWINGS

The description herein makes reference to the accompanying drawings wherein like reference numerals refer to like parts, and wherein:

FIG. 1 is a block diagram of an example computing device in accordance with an embodiment.

FIG. 2 is a schematic diagram of an example system comprising the computing device in FIG. 1.

FIG. 3 is an example block diagram of the system in FIG. 2.

FIG. 4 is a flow diagram of an example method of operations of computing device in FIG. 1.

### DETAILED DESCRIPTION

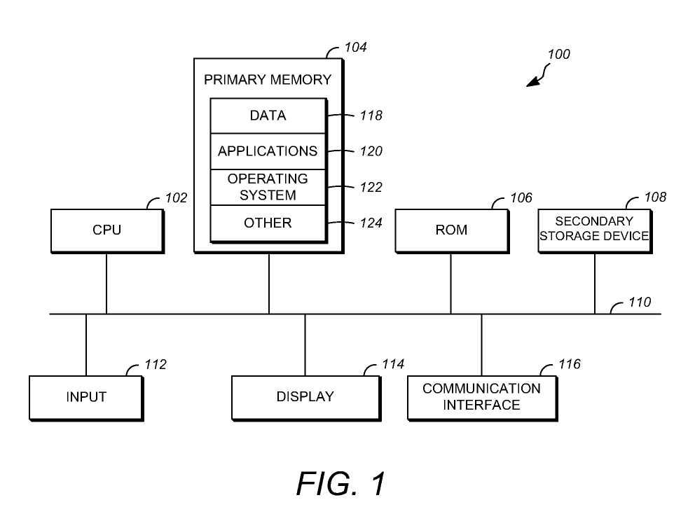

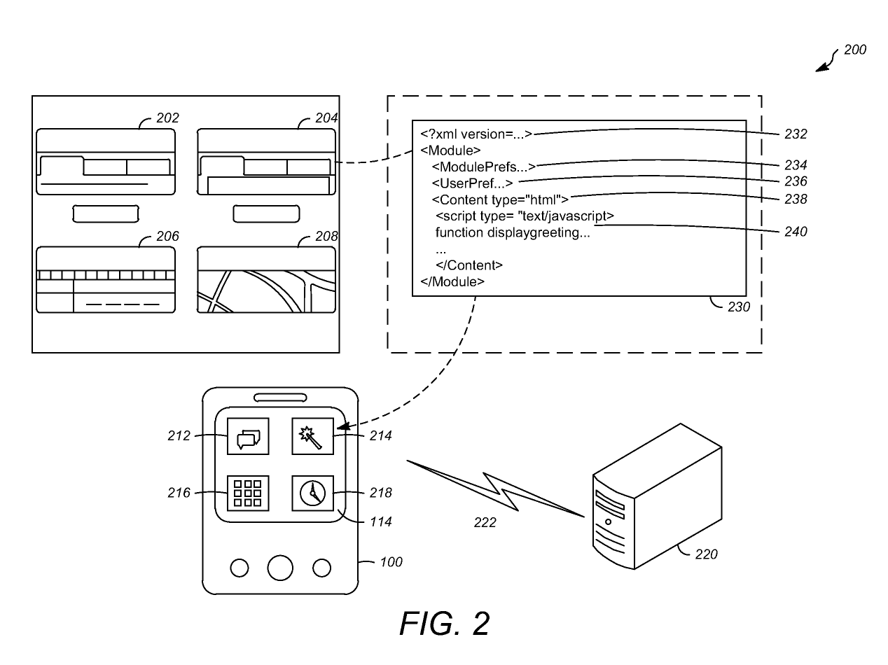

FIG. 1 is a block diagram of an example computing device in accordance with an embodiment. The example computing device depicted in FIGS. 1 and 2 is a mobile device 100. In other embodiments, computing device can be a personal computer, a server, a workstation, a personal digital assistant, a laptop, an e-book reader, a game console, a navigation device, a wearable computer, any other computing device, or a combination of any two or more of these devices.

As shown in FIG. 1, mobile device 100 can include a central processing unit (CPU) 102, at least one memory, an input device 112, a display device 114, and a communication interface 116. The at least one memory can include a primary memory 104, a read-only memory (ROM) 106, a secondary storage device 108, or a combination of any of the above. Communication interface 116 can include any wired or wireless communication means for transmission and/or receipt of data or signals, via a network of any type. The various components of mobile device 100 can be connected and/or coupled to at least one communication bus 110.

Primary memory 104 can include, for example, random access memory (RAM) or other tangible computer readable medium that is accessible by CPU 102. Secondary storage device 108 can include any persistent computer readable medium, such as a hard disk drive, a solid state drive, a memory card, a flash memory device, a removable media, or other suitable storage medium. Although depicted as a unitary device, CPU 102 can include or comprise multiple processors. Similarly, other components of mobile device 100, such as primary memory 104 and secondary storage device 108, can be deployed in multiple devices such as an array of memory units deployed on a network. References in the singular to “processor” or “memory” or other components of mobile device 100 are intended to encompass implementations where multiple units (including different types of such units) are deployed to perform the functions described herein.

Mobile device 100 can further include various machine-readable information components stored in primary memory 104, including, for example data 118, applications 120, an operating system 122, and other components 124. Machine-readable information components 118, 120, 122, 124 can also be stored in other locations such as ROM 106 or secondary storage device 108. In some implementations, machine-readable information components can include instructions that, when executed by a processor such as CPU 102, can cause mobile device 100 to perform operations including those described below. Part of the machine-readable information components can also be stored at a different computing device (e.g., a server) and accessed by mobile device 100 through communication interface 116.

Display device 114 can be any suitable device for displaying output from mobile device 100 or another computing device. For example, display device 114 can be an LCD, LED or CRT display. Display device 114 is operable to display information, such as a user interface comprising interface elements such as screen icons or menu items for applications 120, which can be accessed by a user of mobile device 100. In other embodiments, input device 112 or display device 114 can be physically separate from mobile device 100, and can be operatively and/or physically coupled to CPU 102, to primary memory 104, to ROM 106, to secondary storage device 108, and/or to communication interface 116 via one or more physical and/or logical connections and/or links.

FIG. 2 is a schematic diagram of an example system 200 comprising mobile device 100 and a server 220. Server 220 can include any device that has a processor and a memory, such as a PC, a workstation, a distributed computing system, a cloud computing device, a computer cluster, an embedded system, a unitary electric device, a networking device, a mobile device, any other computing device, or a combination of any two or more of these devices. Mobile device 100 can communicate with server 220 through network 222. Network 222 can be any type of network that can transmit data or signals, such as the Internet or a cellular network.

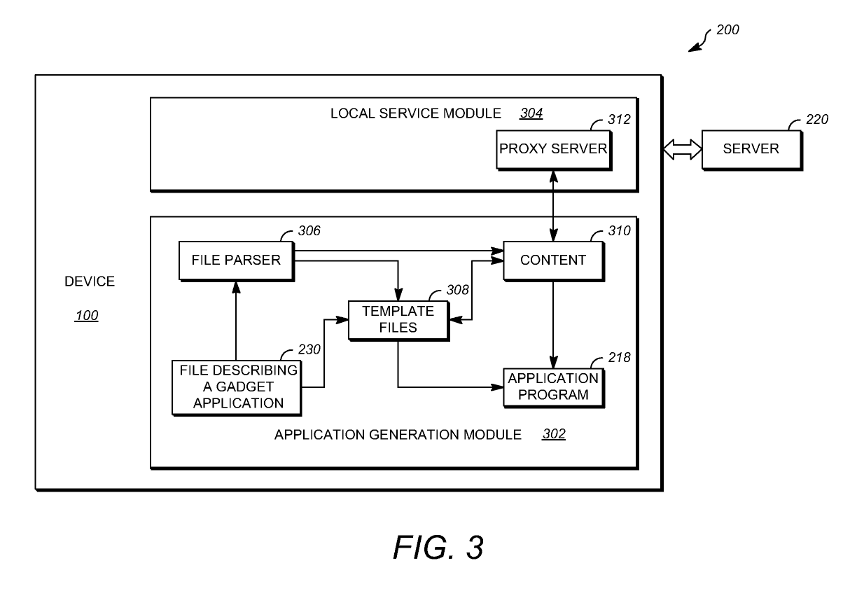

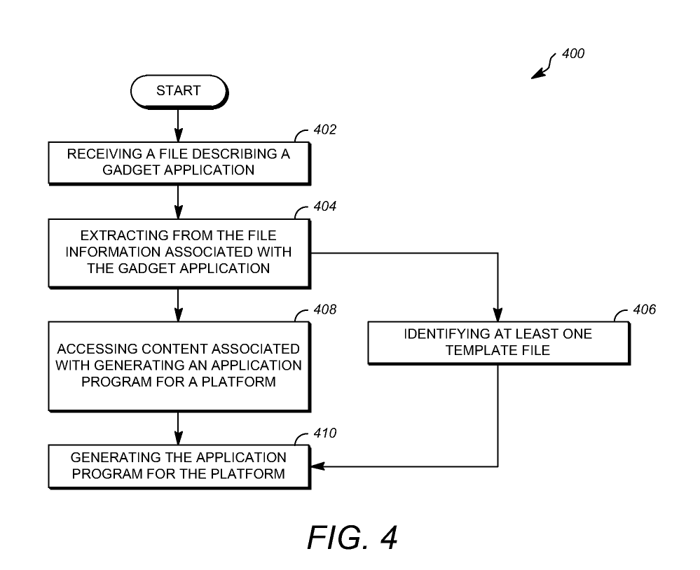

As seen in FIG. 2, mobile device 100 can receive a file 230 describing a gadget application 204. The file 230 can be received from a memory at mobile device 100 or elsewhere, such as, for example, a website where the gadget application 204 is hosted. As will be described in FIGS. 3 and 4, an application program 214 can be generated for a platform associated with mobile device 100 from the file 230 describing gadget application 204. The platform associated with mobile device 100 can include, for example, a mobile operating system. In some embodiments, the platform associated with mobile device can include additional information associated with mobile device 100 such as screen resolution or browser size. The application program 214 generated from gadget application 204, along with other application programs such as 212, 216, 218, can be executed at mobile device 100.

In FIG. 2, file 230 can include a line 232 to describe a format of file 230, in this example the Extensible Markup Language (XML) format. The format of file 230 can also include HyperText Markup Language (HTML), JavaScript, or any other format that can be read by mobile device 100, or any combination of the above. For example, file 230 can be in XML format, but can also include content (such as data and/or code) written in another format such as HTML or JavaScript. File 230 can include specifications for gadget application 204, such as instructions on how to process and/or render the gadget application 204. File 230 can also include references, such as Uniform Resource Locators (URLs), which can be used to extract location information for accessing some of the content of the gadget application 204.

In line 234 of file 230, for example, <ModulePrefs . . . > tag can contain information about the gadget application 204 such as title, description, author, and other features. Line 236 starting with <UserPref . . . > can indicate some of the user preferences for the gadget application 204. Line 238 starting with <Content type=“html”> can include some of the content of the gadget application 204 in HTML format. Block 240 starting with <script type=“text/javascript> can include some of the content of the gadget application 204 in program code such as JavaScript. For example, block 240 can include a function to display a greeting.

FIG. 3 is an example block diagram of system 200 of FIG. 2. Mobile device 100 can include an application generation module 302 and a local service module 304 in one or more machine-readable information components, such as in applications 120 or operating system 122.

Application generation module 302 can include a file parser 306. Upon receiving file 230 describing gadget application 204, mobile device 100 can use file parser 306 to extract information associated with gadget application 204. Information extracted from file 230 can include, for example, content information, user data and other data associated with gadget application 204. User data can include, for example, language preferences selected by the user, runtime environment defined by the user, information entered by the user, etc. Other data associated with gadget application 204 can include, for example, application name, author, suggested size, or any other information otherwise relating to gadget application 204. Content information can include, for example, static content (such as HTML text), dynamic content (such as JavaScript code), references (such as URLs), and/or information associated with Application Programming Interface (API) accessible to gadget application 204. Information extracted from file 230 can be used to generate application program 214, as will be described.

Mobile device 100 can use local service module 304 to access some of the content 310 for generating application program 214 based on the information extracted from file 230. Local service module 304 can include a proxy server 312. Proxy server 312 can send a content request to server 220. For example, the content request can include a URL address extracted from the file 230. Some of the content 310 for generating application program 214 can also be accessed at local memory of mobile device 100, such as when some of the content 310 has already been stored at mobile device 100 prior to the content request, or from content information extracted from the file 230.

In some embodiments, proxy server 312 can intercept the content request from mobile device 100 to server 220. Thus, when proxy server 312 determines the requested content 310 is already at mobile device 100, computing device 100 can access the requested content 310 without connecting to server 200.

In some embodiments, local service module 204 can pre-fetch some of the content 310 that has yet to be requested by application program 214 based on information extracted from file 230, such as an image URL, code in JavaScript or Cascade Style Sheet (CSS). Thus, when mobile device 100 executes application program 214, some of the content 310 for application program 214 can be accessed on mobile device 100, without the need to connect to a remote location.

Mobile device 100 can use application generation module 306 to identify at least one template file 308 configured for the platform associated with mobile device 100. Template file 308 can include standard application information associated with the platform, such as logo or icons, application names, application descriptions, resource locator, etc.

To generate application program 214, application generation module 306 can use template file 308, information extracted from file 230, some of the content accessed by proxy server 312, or any combination of the above. In some cases, application program 214 can be generated as executable programs that can run on mobile device 100. For example, the user can access application program 214 on mobile device 100 by clicking on an interface element (such as an icon) of the generated application program 214 on the user interface displayed on mobile device 100. Alternatively, applications program 214 can be generated on mobile device 100 and executed on a different device.

FIG. 4 is a flow diagram of an example method of operations of mobile device 100 in accordance with an embodiment. Method 400 can commence with step 402, where mobile device 100 receives file 230 describing gadget application 204. File 230 can be in XML format.

At step 404, information associated with gadget application 204 is extracted from file 230. Information extracted from the file 230 can include, for example, user data such as birthday information or location, and other information associated with generating the gadget application 214. In some examples, some of the content 310 for generating the application program 214, such as some static web content in HTML format, can also be extracted.

At step 406, at least one template file 308 configured for the platform associated with mobile device 100 can be identified. At step 408, some of the content 310 associated with generating the application program 214 can be accessed based at least in part on the information associated with the gadget application 204. Some of content 310 can be accessed from the memory of the mobile device 100, server 220, or from the file 230 describing the gadget application. In some examples, address of the server 220 can be identified from link information extracted from the file 230. Some of the content 310 for generating the application program 214 can also be accessed from, for example, a cloud device, a personal computer, or any other computing device accessible to mobile device 100.

At step 410, mobile device 100 generates application program 214 based at least in part on template file 308, and the content 310 for generating the application program 214.

In another embodiment (not shown), the gadget application 214 can be generated at another computing device such as server 220. The operations can commence with server 220 extracting information associated with gadget application 204 from file 230. Then, server 220 can identify at least one template file 308 associated with a platform that application program 214 can be executed on. Meanwhile, server 220 can access some of content 310 associated with generating application program 214 based at least in part on the information associated with gadget application 204. Thereafter, server 220 can generate application program 214 based at least in part on the template file 308 and the content 310 associated with generating the application program 214.

Generated application program 214 can be executed at mobile device 100 or another device. When executing application program 214, device can use proxy server 312 to intercept content request or pre-fetch some of the content 310 for application program 214.

The term “processor” should be understood to encompass any CPU (whether single or multiple core), microprocessor, microcontroller, ASIC, PLA, optical processor, or any device or group of devices whatsoever that is capable of processing information including groups of the foregoing operating in parallel. The term “memory” means any tangible device or group of devices capable of storing information, where volatile or non-volatile, primary or secondary, including without limitation RAM, ROM, or disk drives.

Further, all or a portion of the disclosed embodiments or implementations can take the form of a computer program product accessible from, for example, a computer-usable or computer-readable medium such as primary memory 104 or any other computer-usable or computer-tangibly contain, store, communicate, or transport the program for use by or in connection with any processor. The medium can be, for example, an electronic, magnetic, optical, electromagnetic, or a semiconductor device. Other suitable mediums are also available. Computer-executable instructions for performing the techniques described herein (including method 400 shown in FIG. 4) can be stored in memory such as primary memory 104 and executed by a computing device such as mobile device 100 causing mobile device 100 to perform the some or all of the methods and other techniques described above.

The above-described embodiments or implementations have been described in order to allow easy understanding and do not limit the present disclosure. On the contrary, the present disclosure is intended to cover various modifications and equivalent arrangements included within the scope of the appended claims, which scope is to be accorded the broadest interpretation so as to encompass all such modifications and equivalent structure as is permitted under the law.

1. A method comprising:
receiving, at a mobile device, from one or more server computers, a file that is interpretable by a host application to cause execution of a gadget application within the host application;
extracting, from the file, information associated with the gadget application;
identifying at least one template configured for a platform associated with the mobile device; and
generating, at the mobile device, an application program based at least in part on the template and the information associated with the gadget application, wherein the application program is executable by the mobile device.

2. The method of claim 1, further comprising:
accessing content associated the gadget application, wherein generating the application program is based further in part on the content associated with the gadget application.

3. The method of claim 2, further comprising:
storing, at a memory of the mobile device, the content associated with the gadget application.

4. The method of claim 2, wherein the content associated with the gadget application is accessed from at least one of: a memory of the mobile device, a server, or the file.

5. The method of claim 2, wherein the content associated with the gadget application includes user data.

6. The method of claim 1, wherein the platform comprises a mobile operating system.

7. The method of claim 1, wherein the file is defined by Extensible Markup Language (XML).

8. A method comprising:
extracting, at a computing device, information associated with a gadget application from a file that is interpretable by a host application to cause execution of the gadget application within the host application;
identifying at least one template associated with a platform using at least some of the information associated with the gadget application; and
generating, at the computing device, an application program based at least in part on the template and the information associated with the gadget application, wherein the application program is executable by the computing device.

9. The method of claim 8, wherein the host application is a web browser and the platform comprises a mobile operating system.

10. The method of claim 8, wherein the file is defined by Extensible Markup Language (XML).

11. A computing device comprising:
at least one memory; and
at least one processor configured to execute instructions stored in the at least one memory to:
receive a file that is interpretable by a host application to cause execution of a gadget application within the host application;
extract, from the file, information associated with the gadget application;
identify at least one template configured for a platform associated with the at least one processor; and
generate an application program based at least in part on the template and the information associated with the gadget application, wherein the application program is executable by the at least one processor.

12. The computing device of claim 11, wherein the at least one memory further includes instructions to:
access content associated with the gadget application, wherein the application program is generated based further in part on the content associated with the gadget application.

13. The computing device of claim 12, wherein the at least one memory further includes instructions to:
store, at the at least one memory, the content associated with the gadget application.

14. The computing device of claim 12, wherein the content associated with the gadget application is accessed from at least one of: the at least one memory, a server, or the file.

15. The computing device of claim 12, wherein the content associated with the gadget application includes user data.

16. The computing device of claim 11, wherein:
the host application is a web browser;
the platform comprises a mobile operating system; and
the file is defined by Extensible Markup Language (XML).

17. A non-transitory computer-readable medium having stored thereon instructions executable by one or more computing devices to cause the one or more computing devices to:
receive, at the one or more computing devices, a file that is interpretable by a host application to cause execution of a gadget application within the host application;
extract, from the file, information associated with the gadget application;
identify at least one template configured for a platform associated with the one or more computing device; and
generate, at the one or more computing devices, an application program based at least in part on the template and the information associated with the gadget application, wherein the application program is executable by the one or more computing devices.

18. The non-transitory computer-readable medium of claim 17, further comprising instructions executable by the one or more computing devices to cause the one or more computing devices to:
access content associated with the gadget application, wherein the application program is generated based further in part on the content associated with the gadget application; and
store, at the one or more computing devices, the content associated with the gadget application.

19. The non-transitory computer-readable medium of claim 18, wherein the content associated with the gadget application is accessed from at least one of: at least one memory of the computing device, a server, or the file.

20. The non-transitory computer-readable medium of claim 17, wherein:
the host application is a web browser;
the platform comprises a mobile operating system; and
the file includes Extensible Markup Language (XML).
